(19) United States
(12) Patent Application Publication
(10) Pub. No.: US 2015/0370487 A1
(43) Pub. Date: Dec. 24, 2015

(54) STORAGE DEVICE AND ADDRESS-CORRESPONDING METHOD, DATA-ACCESSING METHOD, AND IDENTIFYING AND ACCESSING METHOD THEREOF

(71) Applicant: APACER TECHNOLOGY INC., New Taipei City (TW)

(72) Inventor: Jiunn-Chang Lee, New Taipei City (TW)

(21) Appl. No.: 14/526,011

(22) Filed: Oct. 28, 2014

(30) Foreign Application Priority Data
Jun. 24, 2014 (TW) 103121656

(51) Int. Cl. G06F 3/06; G06F 12/02

(52) U.S. Cl. CPC G06F 3/0608; G06F 12/0246; G06F 3/064; G06F 3/0644; G06F 3/0688; G06F 2212/1044; G06F 2212/152; G06F 2212/2022; G06F 2212/214; G06F 2212/2532; G06F 2212/261; G06F 2212/7202; G06F 2212/7204; G06F 2212/7208

(57) ABSTRACT

A storage device is connected with a host. The storage device includes a control module, a first storage module and a second storage module. The first storage module having a first storage region and a second storage region is connected with the control module. The second storage module is connected with the control module. To-be-accessed data are stored and read in the first storage region or the second storage region of the first storage module by the control module. The to-be-accessed data stored and read in the first storage region are correspondingly stored and read in the second storage module by the control module, so that the second storage region is exclusively used for temporary storage of data, the storage modules are effectively utilized, and the lifetime decrease of the storage device is avoided.

### FIELD OF THE INVENTION

The present invention relates to a storage device, and more particularly to a storage device and an address-corresponding method, a data-accessing method and an identifying and accessing method thereof.

### BACKGROUND OF THE INVENTION

With growing of the human civilization, science, technology and modernization, the development of data storage approaches mature and perfect. A variety of storage devices are developed for storing data. In recent years, solid-state disks (SSDs) play an important role in the industry.

In general, A SSD can be a 2.5 inches disk, a small module or a small chip. The usage of SSD is gradually increased for replacing the conventional hard-disk drive (HDD). Since SSD significantly exceeds HDD in transfer speed, a volatile memory, such as a double data rate synchronous dynamic random access memory (DDR SDRAM), is utilized for increasing the instant transfer speed in the hardware and firmware design of SSD. Therefore, the accessing speed of random data is relatively enhanced.

However, the volatile memory of SSD is usually not completely utilized. A portion of the storage space is often idle that wastes a lot of performance of SSD. Additionally, the limitation of write times of SSD is stricter than the one of HDD. Under this circumstance, when the producer or the user wants to utilize the idle portion of the storage space for data temporary storing, the lifetime of SSD is decreased due to the characteristics of the corresponding relationship between the volatile memory and the flash memory of SSD.

Therefore, there is a need of providing an improved storage device and an improved address-corresponding method, an improved data-accessing method and an improved identifying and accessing method thereof in order to overcome the above drawbacks.

### SUMMARY OF THE INVENTION

The present invention provides a storage device and an address-corresponding method, a data-accessing method and an identifying and accessing method thereof in order to overcome the above-mentioned drawbacks encountered by the prior arts.

The present invention provides a storage device and an address-corresponding method, a data-accessing method and an identifying and accessing method thereof. By using the second storage region of the first storage module as a data temporary storing region, the storage modules are effectively utilized, and the lifetime decrease of the storage device is avoided.

The present invention provides a storage device and an address-corresponding method, a data-accessing method and an identifying and accessing method thereof. Since the first storage region and the second storage region are respectively corresponding to the first address segment and the second address segment of the logical block address of the host, the first storage region or the second storage region is selectively utilized as the data temporary storing region, or the second storage module or the second storage region is selectively accessed to implement the data accessing.

In accordance with an aspect of the present invention, there is provided a storage device. The storage device includes a control module, a first storage module and a second storage module. The first storage module having a first storage region and a second storage region is connected with the control module. The second storage module is connected with the control module. To-be-accessed data are stored and read in the first storage region or the second storage region of the first storage module by the control module. The to-be-accessed data stored and read in the first storage region are correspondingly stored and read in the second storage module by the control module.

In accordance with another aspect of the present invention, there is provided an address-corresponding method. The address-corresponding method includes steps of providing a storage device, which includes a first storage module having a first storage region and a second storage region and a second storage module, and a host, connecting the storage device and the host, corresponding the first storage region and the second storage region to a first address segment and a second address segment of a logical block address of the host, and corresponding the first address segment of the logical block address to a physical block address of the host.

In accordance with another aspect of the present invention, there is provided a data-accessing method. The data-accessing method includes steps of providing a storage device, which includes a first storage module having a first storage region and a second storage region and a second storage module, and a host, connecting the storage device and the host, determining if to-be-accessed data are required to be accessed in the second storage module, and when the result is true, the first storage region is utilized as a data temporary storing region, and when the result is false, the second storage region is utilized as the data temporary storing region, so that the data accessing is implemented.

In accordance with another aspect of the present invention, there is provided an identifying and accessing method. The identifying and accessing method includes steps of providing a storage device, which includes a first storage module having a first storage region and a second storage region and a second storage module, and a host, connecting the storage device and the host, allowing the host to identify the second storage module and the second storage region of the first storage module as a first storage space and a second storage space, and selectively accessing the first storage space or the second storage space to implement the data accessing.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the configuration of a storage device according to an embodiment of the present invention;

FIG. 2 schematically illustrates the corresponding relationship of a first storage region, a second storage region, a logical block address and a physical block address according to an embodiment of the present invention;

FIG. 3 schematically illustrates the flow chart of the address-corresponding method according to an embodiment of the present invention;

FIG. 4 schematically illustrates the flow chart of the data-accessing method according to an embodiment of the present invention; and

FIG. 5 schematically illustrates the flow chart of the identifying and accessing method according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

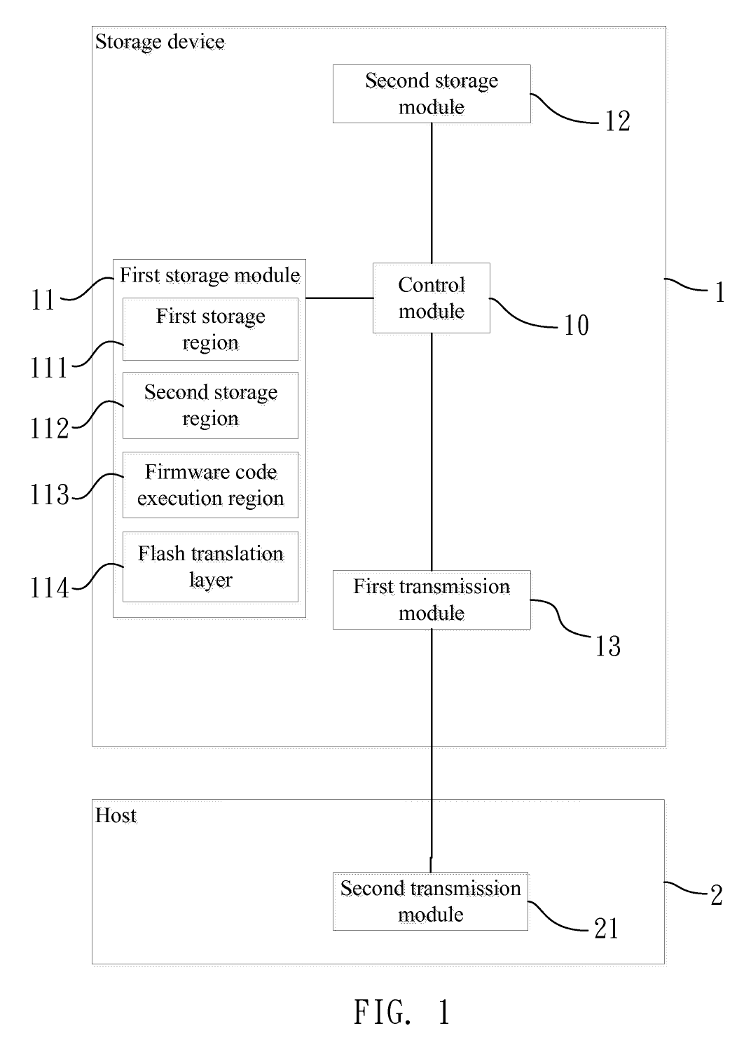

Please refer to FIG. 1. FIG. 1 schematically illustrates the configuration of a storage device according to an embodiment of the present invention. A storage device 1 of the present invention is connected with a host 2. The storage device 1 includes a control module 10, a first storage module 11 and a second storage module 12. The control module 10 is configured for controlling the total operation of the storage device 1 or the operations of the first storage module 11 and the second storage module 12. The first storage module 11 is not limited to a volatile memory, such as a double data rate synchronous dynamic random access memory (DDR SDRAM), and is connected with the control module 10. The first storage module 11 has a first storage region 111 and a second storage region 112. The second storage module 12 is a non-volatile storage module, such as a flash memory, but not limited herein. The second storage module 12 is connected with the control module 10. To-be-accessed data are stored and read in the first storage region 111 or the second storage region 112 of the first storage module 11 by the control module 10. The to-be-accessed data stored and read in the first storage region 111 of the first storage module 11 are correspondingly stored and read in the second storage module 12 by the control module. In other words, the second storage region 112 is not directly corresponded to a physical region or a physical address of the second storage module 12, so that the second storage region 112 can be directly used as a data temporary storing region. In particular, the second storage region 112 is exclusively used for temporary storage of data, the storage modules (i.e. the first storage module 11 and the second storage module 12) are effectively utilized, and the lifetime decrease of the storage device 1 is avoided.

In this embodiment, the storage device 1 further includes a first transmission module 13, and the host 2 includes a second transmission module 21. The connection between the storage device 1 and the host 2 is implemented through the connection of the first transmission module 13 and the second transmission module 21, but not limited thereto. Moreover, the first transmission module 13 is matched with the second transmission module 21, and the first transmission module 13 is connected with the second transmission module 21 through a peripheral component interconnect express (PCI-E) technology or a serial advanced technology attachment (SATA) technology.

In some embodiments, the first storage module 11 of the storage device 1 further has a firmware code execution region 113 and a flash translation layer 114 for executing a firmware code or updating the firmware, and transforming or translating the flash memory, respectively.

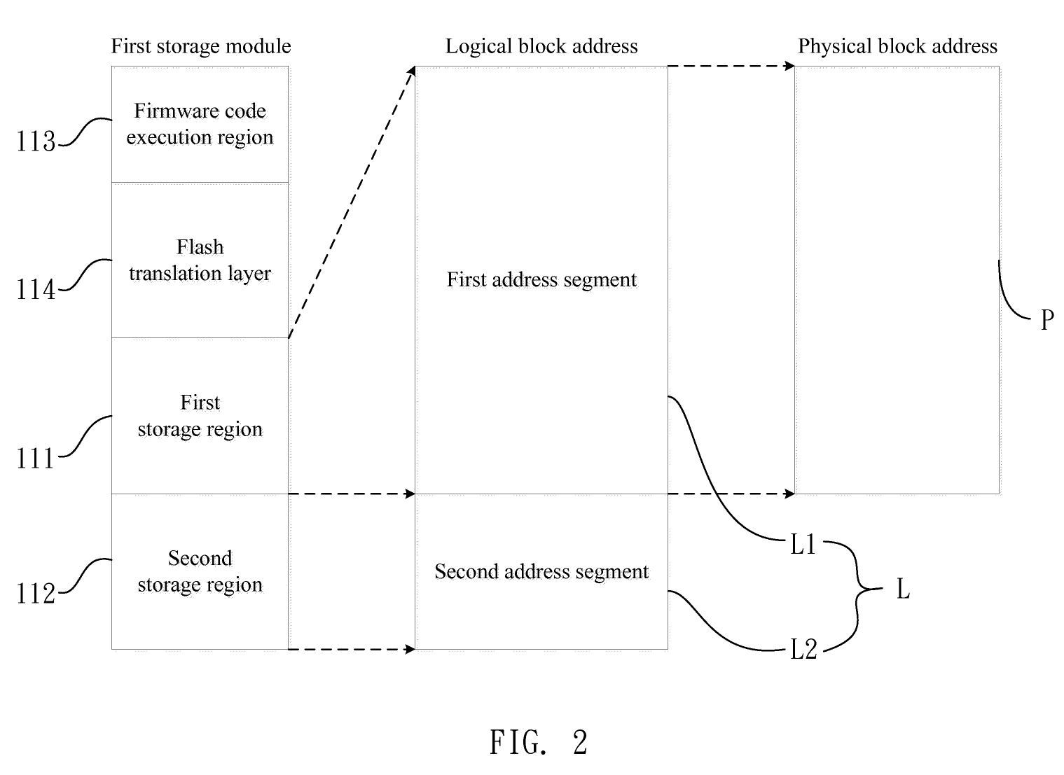

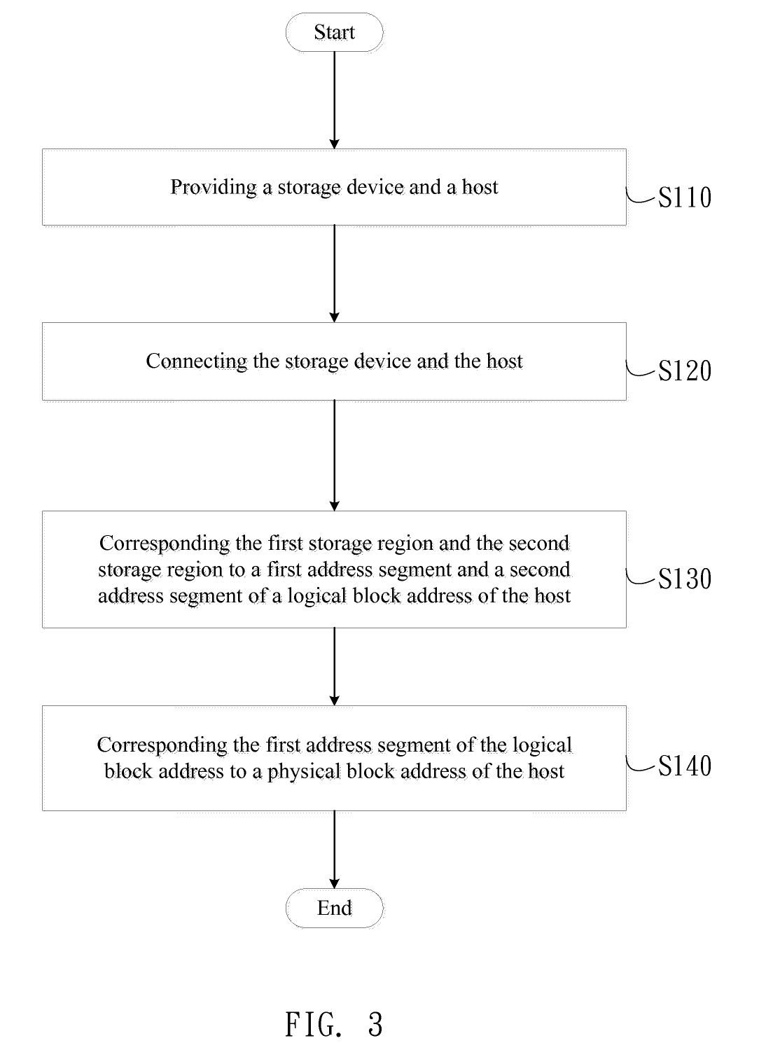

Please refer to FIG. 1, FIG. 2 and FIG. 3. FIG. 2 schematically illustrates the corresponding relationship of a first storage region, a second storage region, a logical block address and a physical block address according to an embodiment of the present invention. FIG. 3 schematically illustrates the flow chart of the address-corresponding method according to an embodiment of the present invention. As shown in FIGS. 1-3, an address-corresponding method of the present invention includes steps as follows. At first, providing a storage device 1 and a host 2 as shown in step S110. The storage device 1 includes a first storage module 11 and a second storage module 12, and the first storage module 11 has a first storage region 111 and a second storage region 112. Next, as shown in step S120, connecting the storage device 1 and the host 2. Then, as shown in step S130, corresponding the first storage region 111 and the second storage region 112 to a first address segment L1 and a second address segment L2 of a logical block address L of the host 2. Next, corresponding the first address segment L1 of the logical block address L to a physical block address P of the host 2 as shown in step S140. That is, the second storage region 112 is only corresponded to the second address segment L2 of the logical block address L of the host 2 but not corresponded to the physical block address P of the host 2, such that the second storage region 112 can be directly used as a data temporary storing region. Therefore, the second storage region 112 is exclusively used for temporary storage of data, the storage modules are effectively utilized, and the lifetime decrease of the storage device 1 is avoided.

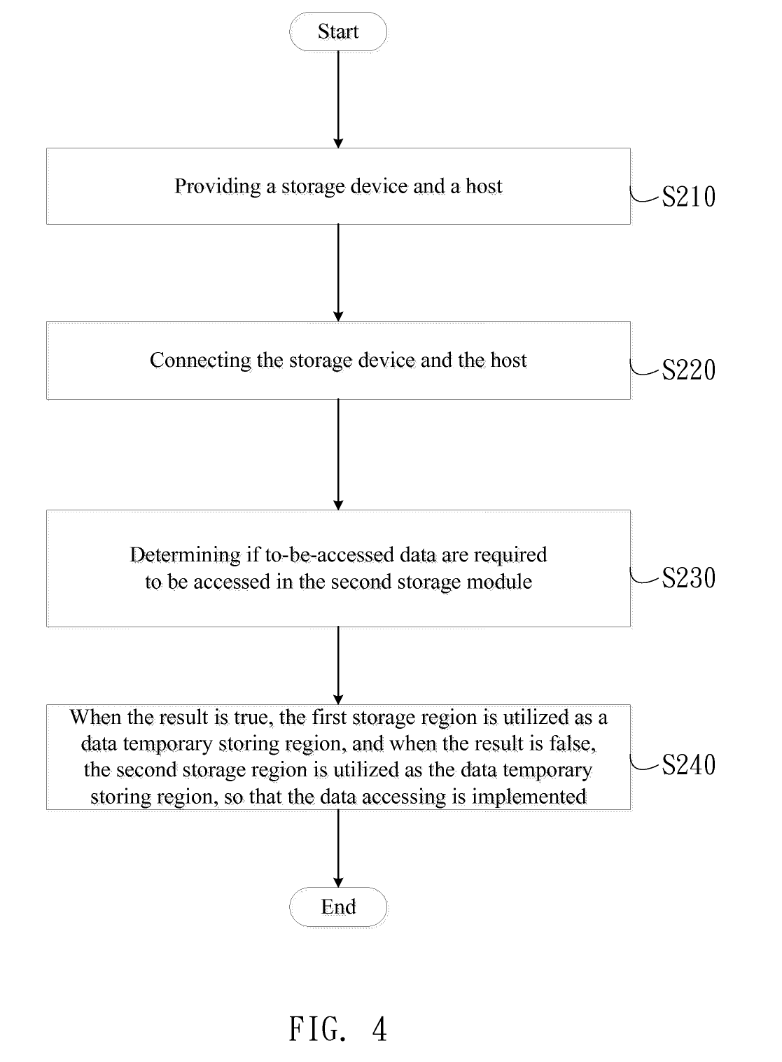

Please refer to FIG. 1 and FIG. 4. FIG. 4 schematically illustrates the flow chart of the data-accessing method according to an embodiment of the present invention. As shown in FIG. 1 and FIG. 4, a data-accessing method of the present invention includes steps as follows. At first, providing a storage device 1 and a host 2 as shown in step S210. The storage device 1 includes a first storage module 11 and a second storage module 12, and the first storage module 11 has a first storage region 111 and a second storage region 112. Next, as shown in step S220, connecting the storage device 1 and the host 2. Then, as shown in steps S230 and S240, determining if to-be-accessed data are required to be accessed in the second storage module 12. When the result is true, the first storage region 111 is utilized as a data temporary storing region, and when the result is false, the second storage region 112 is utilized as the data temporary storing region, so that the data accessing is implemented. Under this circumstance, the first storage region 111 or the second storage region 112 is selectively utilized as the data temporary storing region through the data-accessing method mentioned above, but not limited herein.

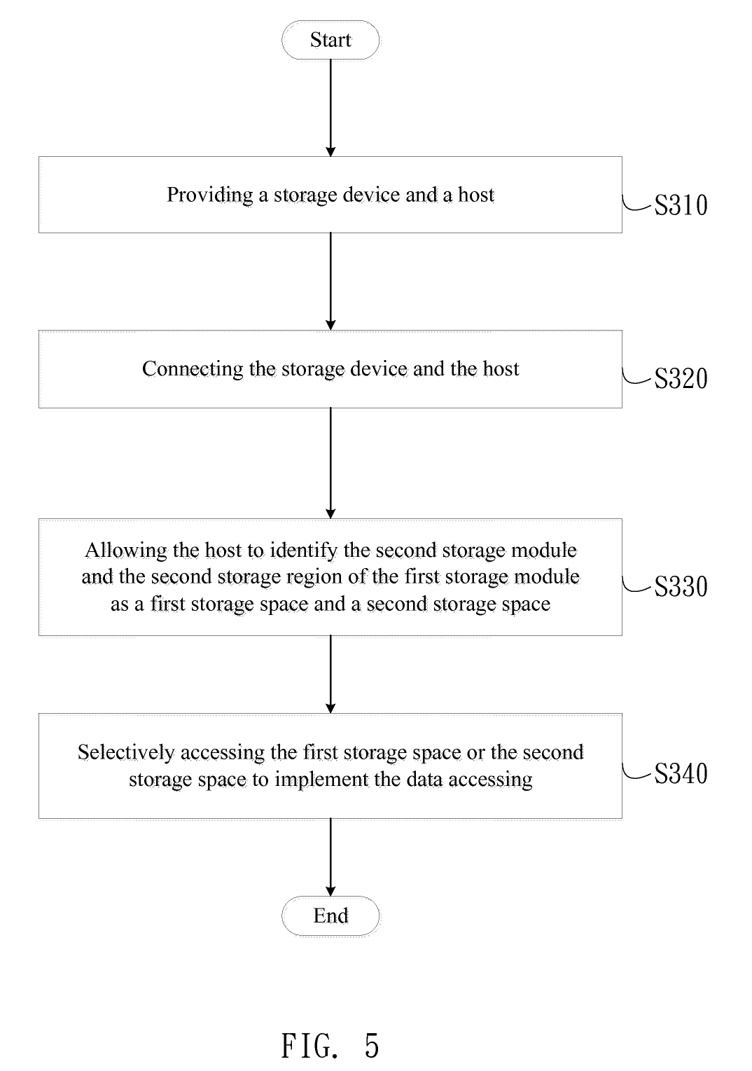

Please refer to FIG. 1 and FIG. 5. FIG. 5 schematically illustrates the flow chart of the identifying and accessing method according to an embodiment of the present invention. As shown in FIG. 1 and FIG. 5, an identifying and accessing method of the present invention includes steps as follows. At first, providing a storage device 1 and a host 2 as shown in step 5310. The storage device 1 includes a first storage module 11 and a second storage module 12, and the first storage module 11 has a first storage region 111 and a second storage region 112. Next, as shown in step 5320, connecting the storage device 1 and the host 2. Then, as shown in step 5330, allowing the host 2 to identify the second storage module 12 and the second storage region 112 of the first storage module 11 as a first storage space and a second storage space, respectively, such as disk C and disk D in Windows® OS, two individual disks in Macintosh® OS, or the like. Next, selectively accessing the first storage space or the second storage space to implement the data accessing as shown in step 5340. As shown in FIGS. 1-5 and described in the above-mentioned embodiments, since the first storage region 111 and the second storage region 112 are respectively corresponding to the first address segment L1 and the second address segment L2 of the logical block address L of the host 2, the first storage region 111 or the second storage region 112 is selectively utilized as the data temporary storing region, or the second storage module 12 or the second storage region 112 is selectively accessed to implement the data accessing.

From the above descriptions, the present invention provides a storage device and an address-corresponding method, a data-accessing method and an identifying and accessing method thereof. By using the second storage region of the first storage module as a data temporary storing region, the storage modules are effectively utilized, and the lifetime decrease of the storage device is avoided. Meanwhile, since the first storage region and the second storage region are respectively corresponding to the first address segment and the second address segment of the logical block address of the host, the first storage region or the second storage region is selectively utilized as the data temporary storing region, or the second storage module or the second storage region is selectively accessed to implement the data accessing.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A storage device connected with a host, comprising:
a control module;
a first storage module connected with the control module, wherein the first storage module has a first storage region and a second storage region; and
a second storage module connected with the control module, wherein to-be-accessed data are stored and read in the first storage region or the second storage region of the first storage module by the control module, and the to-be-accessed data stored and read in the first storage region are correspondingly stored and read in the second storage module by the control module.

2. The storage device according to claim 1, wherein the first storage module is a volatile storage module, and the second storage module is a non-volatile storage module.

3. The storage device according to claim 2, wherein the first storage module is a double data rate synchronous dynamic random access memory, and the second storage module is a flash memory.

4. The storage device according to claim 1 further comprising a first transmission module, wherein the host comprises a second transmission module, and the first transmission module is connected with the second transmission module.

5. The storage device according to claim 4, wherein the first transmission module is matched with the second transmission module, and the first transmission module is connected with the second transmission module through a peripheral component interconnect express technology or a serial advanced technology attachment technology.

6. The storage device according to claim 1, wherein the first storage module further has a firmware execution region and a flash translation layer.

7. The storage device according to claim 1, wherein the second storage module is identified as a first storage space by the host, and the second storage region is corresponding to a logical block address of the host so as to be a data temporary storing region or identified as a second storage space.

8. An address-corresponding method, comprising steps of:
providing a storage device and a host, wherein the storage device comprises a first storage module and a second storage module, and the first storage module has a first storage region and a second storage region;
connecting the storage device and the host;
corresponding the first storage region and the second storage region to a first address segment and a second address segment of a logical block address of the host; and
corresponding the first address segment of the logical block address to a physical block address of the host.

9. A data accessing method, comprising steps of:
providing a storage device and a host, wherein the storage device comprises a first storage module and a second storage module, and the first storage module has a first storage region and a second storage region;
connecting the storage device and the host;
determining if to-be-accessed data are required to be accessed in the second storage module; and
when the result is true, the first storage region is utilized as a data temporary storing region, and when the result is false, the second storage region is utilized as the data temporary storing region, so that the data accessing is implemented.

10. An identifying and accessing method, comprising steps of:
providing a storage device and a host, wherein the storage device comprises a first storage module and a second storage module, and the first storage module has a first storage region and a second storage region;
connecting the storage device and the host;
allowing the host to identify the second storage module and the second storage region of the first storage module as a first storage space and a second storage space; and
selectively accessing the first storage space or the second storage space to implement the data accessing.
